(19) United States
(12) Patent Application Publication
(10) Pub. No.: US 2024/0270351 A1
(43) Pub. Date: Aug. 15, 2024

(54) VESSEL MOORING

(71) Applicant: Superior-Lidgerwood-Mundy Corporation, Superior, WI (US)

(72) Inventors: Kenneth Leigh Behrman, Plymouth, MN (US); Grant Michael Feldhege, Rogers, MN (US)

(21) Appl. No.: 18/427,916

(22) Filed: Jan. 31, 2024

Related U.S. Application Data
(60) Provisional application No. 63/484,575, filed on Feb. 13, 2023.

(51) Int. Cl. B63B 21/20; G01L 5/04

(52) U.S. Cl. CPC B63B 21/20; G01L 5/04; B63B 2021/203

(57) ABSTRACT

A vessel mooring system includes a tension hoist, an elevation hoist, a sensor, and a programmable controller. The tension hoist is coupled to a mooring line, and the mooring line is configured to couple to a vessel. The elevation hoist is coupled to an elevation line, and the elevation line configured to couple to a mooring cart. The sensor is configured to sense at least one parameter associated with the mooring line. The programmable controller is configured to compare the at least one parameter associated with the mooring line sensed by the sensor to a predetermined mooring line parameter threshold and, when the at least one parameter associated with the mooring line differs from the predetermined mooring line parameter threshold, the programmable controller is configured to cause at least one of the tension hoist to adjust the mooring line and the elevation hoist to adjust the elevation line.

### RELATED APPLICATION

This disclosure claims priority to U.S. provisional patent application No. 63/484,575, filed on Feb. 13, 2023, the entire contents of which are hereby incorporated by reference.

### TECHNICAL FIELD

This disclosure generally relates to vessel mooring systems, devices, and methods. Embodiments are described herein in the context of vessel mooring systems, devices, and methods that can monitor and adjust one or more parameters relating to a moored vessel in a way that can help to reduce or eliminate hands-on manual effort related to vessel mooring.

### BACKGROUND

Vessels are used in a variety of applications to transport goods. In general, a vessel is loaded with goods at a first site, transported to a second site, and unloaded at the second site. In many such applications, while being loaded/unloaded and/or while present at a lock, the elevation of the vessel, relative to a dock at which the vessel is moored, can change because of a change in weight of the vessel and/or because of the water elevation changing at a lock. Changes in elevation of the vessel, relative to the dock at which the vessel is moored, can require adjusting a mooring line that attaches the vessel to the dock.

However, current practice generally requires human presence at the vessel to manually, via a deckhand's hands, adjust the mooring line to compensate for changes in elevation of the vessel relative to the dock. Given the various dynamic forces involved in many mooring applications, human presence at, or near, the vessel can be hazardous. For example, in the case of barges, a fall from the barge can be one primary hazard to the human present at the barge. Because many barge loading/unloading applications can occur at waterways with relatively strong currents, a fall from the barge can be particularly hazardous. As another example, the magnitude of force needed to moor a vessel can be significant, and, as such, these significant forces can pose a danger to a deckhand manually imparting and adjusting these relatively significant forces, particularly in the context of what are often dynamic and changing magnitude of forces as a result of changing weight and/or changes in waterway current.

### SUMMARY

In general, various embodiments relating to vessel mooring systems, devices, and methods are disclosed herein. In particular, embodiments are described herein in the context of vessel mooring systems, devices, and methods that can monitor and adjust one or more parameters relating to a moored vessel (e.g., mooring line tension on a mooring line attached to the moored vessel) in an automated manner.

Such vessel mooring embodiments disclosed herein can be useful, for instance, in reducing deckhand and lock staff personnel interaction with mooring lines, in the case of a barge during the locking process and/or during vessel loading/unloading. In particular, embodiments disclosed herein can monitor one or more parameters relating to one or more mooring lines attached to a vessel and cause a change in one or more parameters (e.g., in an automated manner, such as to cause a change in tension of a mooring line in an automated manner). As one such example, certain embodiments can monitor (e.g., periodically, continuously, or in response to the presence of a preset threshold) tension in a mooring line that is attached to a vessel and, when the monitored tension in the mooring line differs from a predetermined threshold, cause an adjustment in the tension in the mooring line to bring that tension in the mooring line back to the predetermined threshold. This monitoring of tension in the mooring line and adjustment in the tension in the mooring line can be done in an automated manner that reduces or eliminates the presence of a deckhand at the vessel during the monitoring and adjustment process, thereby increasing the efficiency and safety associated with vessel mooring (e.g., during the locking process) by facilitating remote monitoring of, and adjustment to, the mooring line during the vessel mooring process. Exemplary vessels with which vessel mooring embodiments disclosed herein can be used include barges, ships, and train cars.

One embodiment includes a vessel mooring system. This vessel mooring system embodiment can include a tension hoist, an elevation hoist, a mooring cart, a sensor, and a programmable controller. The tension hoist can be configured to couple to a mooring line that is attached to a vessel. The elevation hoist can be configured to couple to an elevation line that is attached to the mooring cart. The sensor can be configured to sense at least one parameter associated with the mooring line (e.g., tension in the mooring line), and the sensor can be coupled to the programmable controller. The programmable controller can be configured to receive data from the sensor, and the programable controller can be configured to use this data from the sensor to monitor the at least one parameter associated with the mooring line (e.g., tension in the mooring line). In particular, the programmable controller can be configured to compare the at least one parameter associated with the mooring line (e.g., tension in the mooring line) to a predetermined parameter threshold and, when the at least one parameter associated with the mooring line differs from the predetermined parameter threshold, the programmable controller can be configured to cause the tension hoist and/or the elevation hoist to adjust the mooring line and/or the elevation line, respectively.

Another embodiment includes a method of mooring a vessel. This method embodiment can include the step of attaching a mooring line to a vessel. This method embodiment can further include the steps of monitoring at least one parameter associated with a mooring line that moors the vessel to a fixed structure (e.g. a dock) and adjusting the at least one parameter associated with the mooring line. For example, the at least one parameter associated with the mooring line can include tension in the mooring line, and, in this example, the method can include monitoring the tension in the mooring line and, when the monitored tension in the mooring line differs from a predetermined mooring line tension threshold, adjusting the tension in the mooring line using a tension hoist and/or an elevation hoist at the fixed structure to bring the tension in the mooring line within the predetermined mooring line tension threshold. Notably, in various embodiments, the monitoring and adjusting steps can be carried out without a need for manual efforts at the mooring line, thereby helping to reduce and/or eliminate manual, hand-on actions for adjusting one or more parameters (e.g., tension) in the mooring line. This method embodiment can further include a step of removing the mooring line from the vessel.

A further embodiment includes a vessel mooring system. This vessel mooring system embodiment includes a tension hoist, an elevation hoist, a sensor, and a programmable controller. The tension hoist is coupled to a mooring line, and the mooring line is configured to couple to a vessel. The elevation hoist is coupled to an elevation line, and the elevation line configured to couple to a mooring cart. The sensor is configured to sense at least one parameter associated with the mooring line. The programmable controller is in communication with the sensor. The programmable controller is configured to compare the at least one parameter associated with the mooring line sensed by the sensor to a predetermined mooring line parameter threshold and, when the at least one parameter associated with the mooring line differs from the predetermined mooring line parameter threshold, the programmable controller is configured to cause at least one of the tension hoist to adjust the mooring line and the elevation hoist to adjust the elevation line.

In a further embodiment of this system, when the at least one parameter associated with the mooring line differs from the predetermined mooring line parameter threshold, the programmable controller is configured to cause at least one of the tension hoist to adjust the mooring line and the elevation hoist to adjust the elevation line to an extent that brings the at least one parameter associated with the mooring line back to the predetermined mooring line parameter threshold. As one example, when the at least one parameter associated with the mooring line differs from the predetermined mooring line parameter threshold, the programmable controller can be configured to cause at least one of the tension hoist to adjust the mooring line and the elevation hoist to adjust the elevation line to an extent that brings the at least one parameter associated with the mooring line back to the predetermined mooring line parameter threshold without manual input.

In these and other various embodiments, for instance, the at least one parameter associated with the mooring line can include tension in the mooring line such that the sensor is configured to sense at least tension at the mooring line. In such examples, the programmable controller can be configured to compare at least tension at the mooring line sensed by the sensor to the predetermined mooring line parameter threshold and, when at least the tension at the mooring line differs from the predetermined mooring line parameter threshold, the programmable controller can be configured to cause at least one of the tension hoist to adjust the mooring line and the elevation hoist to adjust the elevation line to an extent that brings at least the tension at the mooring line back to the predetermined mooring line parameter threshold. As one particular such example, when at least the tension at the mooring line differs from the predetermined mooring line parameter threshold, the programmable controller can be configured to cause both the tension hoist to adjust the mooring line and the elevation hoist to adjust the elevation line to an extent that brings at least the tension at the mooring line back to the predetermined mooring line parameter threshold. To bring the tension at the mooring line back to the predetermined mooring line parameter threshold, the programmable controller can, in certain example embodiments, be configured to: (i) cause the tension hoist to adjust the mooring line by causing the tension hoist to extend or retract the mooring line, relative to the tension hoist, to thereby cause a change in length of the mooring line between the tension hoist and the vessel and (ii) cause the elevation hoist to adjust an elevation of the mooring cart to thereby cause a change in the tension at the mooring line. This can include, in certain example embodiments, the programmable controller being configured to cause the tension hoist to extend or retract the mooring line, relative to the tension hoist, in one direction that is orthogonal to another direction in which the programmable controller is configured to cause the elevation hoist to adjust the elevation of the mooring cart.

For mooring system embodiments that include the mooring cart, such embodiments can further include the mooring cart coupled to each of the mooring line and the elevation line. The mooring cart can be buoyant. The mooring cart can include a line eyelet component that is configured to receive the mooring line therethrough, and the mooring cart can be adjustable in elevation via the elevation line and elevation hoist.

In a further embodiment of this mooring system, the tension hoist can be located at a fixed structure that is adjacent to the vessel, and the elevation hoist can be located at the fixed structure that is adjacent to the vessel. For example, the elevation hoist can be located at the fixed structure in axial alignment with the mooring cart, and the tension hoist can be offset from each of the axially aligned elevation hoist and mooring cart (e.g., such as shown at the illustrated embodiment at FIGS. 1-3).

An additional embodiment includes a method. This method embodiment includes the steps of: attaching a first portion of a mooring line to a vessel, wherein a second portion of the mooring line is attached to a tension hoist; when the mooring line is attached to the vessel, sensing, via a sensor, at least one parameter associated with the mooring line; and when the mooring line is attached to the vessel and when the at least one sensed parameter associated with the mooring line differs from a predetermined mooring line parameter threshold, using the tension hoist to adjust the mooring line to bring the at least one parameter associated with the mooring line within the predetermined mooring line parameter threshold without manual input.

In a further embodiment of this method, using the tension hoist to adjust the mooring line to bring the at least one parameter associated with the mooring line within the predetermined mooring line parameter threshold without manual input can include using a programmable controller, in communication with the sensor, to compare the at least one parameter associated with the mooring line sensed by the sensor to the predetermined mooring line parameter threshold and, when the at least one parameter associated with the mooring line differs from the predetermined mooring line parameter threshold, using the programmable controller to cause the tension hoist to adjust the mooring line without manual input. As one example, the at least one parameter associated with the mooring line can include tension in the mooring line such that sensing, via the sensor, the at least one parameter associated with the mooring line comprises sensing, via the sensor, tension in the mooring line. According to such an example, using the tension hoist to adjust the mooring line to bring the at least one parameter associated with the mooring line within the predetermined mooring line parameter threshold without manual input can include using the programmable controller to compare the tension in the mooring line to the predetermined mooring line parameter threshold and, when the tension in the mooring line differs from the predetermined mooring line parameter threshold, using the programmable controller to cause the tension hoist to adjust the tension in the mooring line without manual input to bring the tension in the mooring line back to the predetermined mooring line parameter threshold.

In a further embodiment of this method, the method can additionally include a step of: when the mooring line is attached to the vessel and to a mooring cart and when the at least one sensed parameter associated with the mooring line differs from a predetermined mooring line parameter threshold, in addition to using the tension hoist to adjust the mooring line, using an elevation hoist to adjust an elevation of the mooring cart to adjust the mooring line to bring the at least one parameter associated with the mooring line within the predetermined mooring line parameter threshold without manual input. As one example, to bring the at least one sensed parameter associated with the mooring line back to the predetermined mooring line parameter threshold, (i) the tension hoist can adjust the mooring line by extending or retracting the mooring line, relative to the tension hoist, to thereby cause a change in length of the mooring line between the tension hoist and the vessel without manual input and (ii) the elevation hoist can adjust the elevation of the mooring cart without manual input. For instance, the tension hoist can adjust the mooring line by extending or retracting the mooring line, relative to the tension hoist, in one direction that is orthogonal to another direction in which the elevation hoist adjusts the elevation of the mooring cart. The mooring cart can be buoyant, and the mooring cart can be coupled to each of the mooring line and the elevation hoist.

The details of one or more examples are set forth in the accompanying drawings and the description below. Other features, objects, and advantages will be apparent from the description and drawings.

### BRIEF DESCRIPTION OF THE DRAWINGS

The following drawings are illustrative of particular embodiments of the present invention and, therefore, do not limit the scope of the invention. The drawings are intended for use in conjunction with the explanations in the following description. Embodiments of the invention will hereinafter be described in conjunction with the appended drawings, wherein like numerals denote like elements. The features illustrated in the drawings are not necessarily to scale, though embodiments within the scope of the present invention can include one or more of the illustrated features (e.g., each of the illustrated features) at the scale shown.

FIG. 1 is a perspective view of an embodiment of an embodiment of a vessel mooring system.

FIG. 2 is a side elevational view of a vessel, at a first elevation, moored to a fixed structure using the vessel mooring system of FIG. 1

FIG. 3 is a side elevational view of the vessel, at a second, different elevation than that shown in FIG. 2, moored to the fixed structure using the vessel mooring system of FIG. 1.

FIG. 4 is a flow diagram of an embodiment of a method of mooring a vessel.

### DETAILED DESCRIPTION

The following detailed description is exemplary in nature and is not intended to limit the scope, applicability, or configuration of the invention in any way. Rather, the following description provides some practical illustrations for implementing embodiments of the present invention. Examples of constructions, materials, and/or dimensions are provided for selected elements. Those skilled in the art will recognize that many of the noted examples have a variety of suitable alternatives.

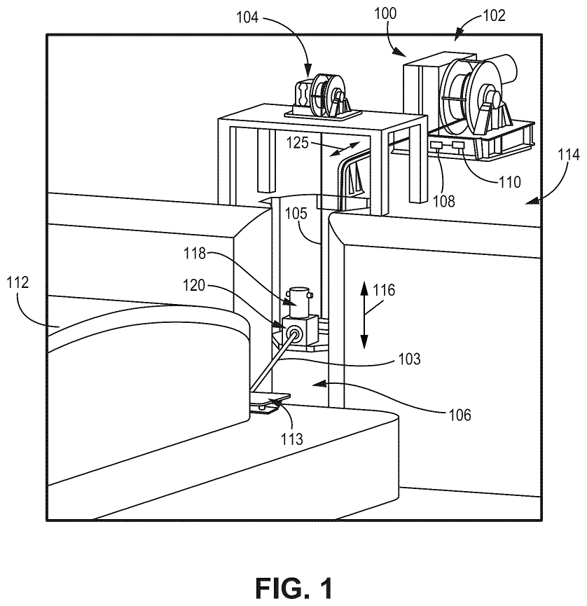

FIG. 1 shows a perspective view of an exemplary embodiment of a vessel mooring system 100. The vessel mooring system 100 can include a tension hoist 102, an elevation hoist 104, a mooring cart 106, a sensor 108, and a programmable controller 110. The tension hoist 102 can be configured to couple to a mooring line 103 that is attached to a vessel 112 (e.g., a barge). As illustrative examples, the mooring line 103 can be a conventional rope or a synthetic material (e.g., Dyneema fiber) line. The elevation hoist 104 can be configured to couple to an elevation line 105 that is attached to the mooring cart 106. As shown for the illustrated embodiment, the tension hoist 102 and the elevation hoist 104 can each be located (e.g., fixed in place) at a fixed structure 114, which here is illustrated as a dock. The mooring line 103 can be attached to the vessel 112 at a vessel attachment point 113 (e.g., a kevel), and the mooring line 103 can serve to moor the vessel 112 at the fixed structure 114, as will be described further herein.

In some embodiments, such as that illustrated, the tension hoist 102 and the elevation hoist 104 can be placed in the system 100 at different orientations. For instance, as shown, the tension hoist 102 can be configured to extend and retract the mooring line 103, relative to the tension hoist 102, in a first direction 125, while the elevation hoist 104 can be configured to extend and retract the elevation line 105, relative to the elevation hoist 104, in a second, different direction 116. The direction 125 can refer to the directional orientation at which the mooring line 103 is extended and retracted, relative to the tension hoist 102, at a segment of the mooring line 103 between the tension hoist 102 and a pulley wheel closest to the tension hoist 102. In the embodiment shown, the direction 125, in which the tension hoist 102 is configured here to extend and retract the mooring line 103, can be generally orthogonal to the direction 116, in which the elevation hoist 104 is configured to extend and retract the elevation line 105. Also in the embodiment shown, the direction 125, in which the tension hoist 102 is configured to extend and retract the mooring line 103, can generally be orthogonal to the vessel 112.

The sensor 108 can be in communication with the programmable controller 110, and the programmable controller 110 can be in communication with the tension hoist 102 and/or the elevation hoist 104. For the exemplary illustrated embodiment, the programmable controller 110 is shown present at the tension hoist 102, but in other embodiments the programmable controller 110 can be located remote of the tension hoist 102 and/or remote of the elevation hoist 104 (e.g., such that the programable controller 110 is a standalone component in the system 100) or the programmable controller 110 can be formed by multiple distributed programmable controllers, for instance one programmable controller at the tension hoist 102 (e.g., first programmable controller 110), one programmable controller at the elevation hoist 104 (e.g., second programmable controller 110a), and/or one programmable controller remote of the tension hoist 102 and remote of the elevation hoist 104 (e.g., the “cloud”/a remote programmable server). The sensor 108 can be configured to sense at least one parameter associated with the mooring line 103. The programmable controller 110 can be configured to receive data from the sensor 108, and the programable controller 110 can be configured to use this data from the sensor 108 to monitor the at least one parameter associated with the mooring line 103. To do so, the programmable controller 110 can include one or more non-transitory computer-readable storage mediums storing computer-executable instructions that, when executed by the programmable controller 110, can cause the programmable controller 110 to use the data from the sensor 108 to monitor at least one parameter associated with the mooring line 103 and/or to cause a change in one or more such monitored parameters associated with the mooring line 103. In particular, the programmable controller 110 can be configured to compare the at least one parameter associated with the mooring line 103 to a predetermined parameter threshold and, when the at least one parameter associated with the mooring line 103 differs from the predetermined parameter threshold, the programmable controller 110 can be configured to cause an adjustment to the at least one parameter associated with the mooring line 103 to bring that at least one parameter associated with the mooring line 103 within the predetermined parameter threshold.

As one example of a parameter of associated with the mooring line 103, the sensor 108 can be configured to detect at least data corresponding to a magnitude of tension force present in the mooring line 103. In this example, the programmable controller 110 can be configured to receive this data corresponding to the magnitude of tension present in the mooring line 103 from the sensor 108, and the programmable controller 110 can be configured to compare the magnitude of tension present in the mooring line 103 to a predetermined tension threshold (e.g., programmed into non-transitory computer-executable instructions stored at the programmable controller 110). When the magnitude of tension present in the mooring line 103 differs from the predetermined tension threshold, the programmable controller 110 can be configured to actuate the tension hoist 102 and/or the elevation hoist 104 to cause the magnitude of tension present in the mooring line 103 to change an amount necessary to bring the magnitude of tension present in the mooring line 103 back within the predetermined tension threshold.

For instance, the programmable controller 110 can actuate the tension hoist 102 to change a length of the mooring line 103 between the tension hoist 102 and the vessel 112 and/or actuate the elevation hoist 104 to change an elevation of the mooring cart 106 as a means to adjust the magnitude of tension present in the mooring line 103 to come within the predetermined tension threshold. In this way, as load requirements change at the lock and/or water elevation at the lock changes, the programmable controller 110 can be configured to automatically actuate the tension hoist 102 and/or the elevation hoist 104 to cause the magnitude of tension in the mooring line 103 to change to be within the predetermined tension threshold without needing a deckhand or other personnel to manually adjust the magnitude of tension in the mooring line 103. This can include, when the magnitude of tension present in the mooring line 103 differs from the predetermined tension threshold, the programmable controller 110 being configured to automatically actuate the tension hoist 102 and/or the elevation hoist 104 to cause the magnitude of tension in the mooring line 103 to change an amount corresponding to a change in elevation of the vessel 112 relative to the fixed structure (e.g., dock) 114 so as to thereby change the tension force in the mooring line 103 to bring the monitored tension in the mooring line 103 back within the predetermined tension threshold without needing a deckhand or other personnel to manually adjust the magnitude of tension in the mooring line 103.

In one embodiment, the vessel mooring system 100 can be configured to generate one or more alerts to a user of the system 100. For example, the system 100 can be configured, such as via the programmable controller 110, to generate one or more audible and/or visible alerts at a user interface. Such one or more audible and/or visible alerts can be generated by the system 100, such as via the programmable controller 110, at a user interface (e.g., at a remote monitoring device, such as a remote computing device) in response to one or more of the measured parameters relating to the mooring line 103. As one example, one or more audible and/or visible alerts can be generated by the system 100 at the user interface when the monitored tension in the mooring line 103 exceeds the predetermined tension threshold. As another example, one or more audible and/or visible alerts can be generated by the system 100 at the user interface when the monitored tension in the mooring line 103 exceeds a predetermined maximum allowable load for the system 100. As a further example, a first type of audible and/or visible alert can be generated by the system 100 at the user interface when the monitored tension in the mooring line 103 exceeds the predetermined tension threshold and a second, different type of audible and/or visible alert can be generated by the system 100 at the user interface when the monitored tension in the mooring line 103 exceeds a predetermined maximum allowable load for the system 100.

For the exemplary, illustrated embodiment, the vessel mooring system 100 can be configured to use a counter-torque function to adjust one or more parameters associated with the mooring line 103. For instance, the vessel mooring system 100 can be configured to use a counter-torque function to adjust the magnitude of tension in the mooring line 103 so as to bring the magnitude of tension in the mooring line 103 within the predetermined tension threshold.

The mooring cart 106 can be adjustable in its height, relative to the fixed structure 114, in a direction 116 (e.g., direction 116 that is orthogonal to vessel 112)). For example, the mooring cart 106 can be attached to the elevation hoist 104 via the elevation line 105. As such, the elevation hoist 104 can be actuated to extend or retract the elevation line 105 relative to the elevation hoist 104 and, as a result, cause the mooring cart 106 to move up or down in the direction 116 relative to the fixed structure 114. The mooring cart 106 can include a line eyelet component 120 for directionally stabilizing the mooring line 103. The mooring cart 106 can be configured to replace a traditional floating mooring bitt at a lock to facilitate the counter-torque function of the vessel mooring system 100. In such instances, the mooring cart 106 can be configured to be used as a traditional floating mooring bitt at a lock. For instance, to help facilitate use as a traditional floating mooring bitt, the mooring cart 106 can include a bollard 118 and the mooring cart 106 can be buoyant.

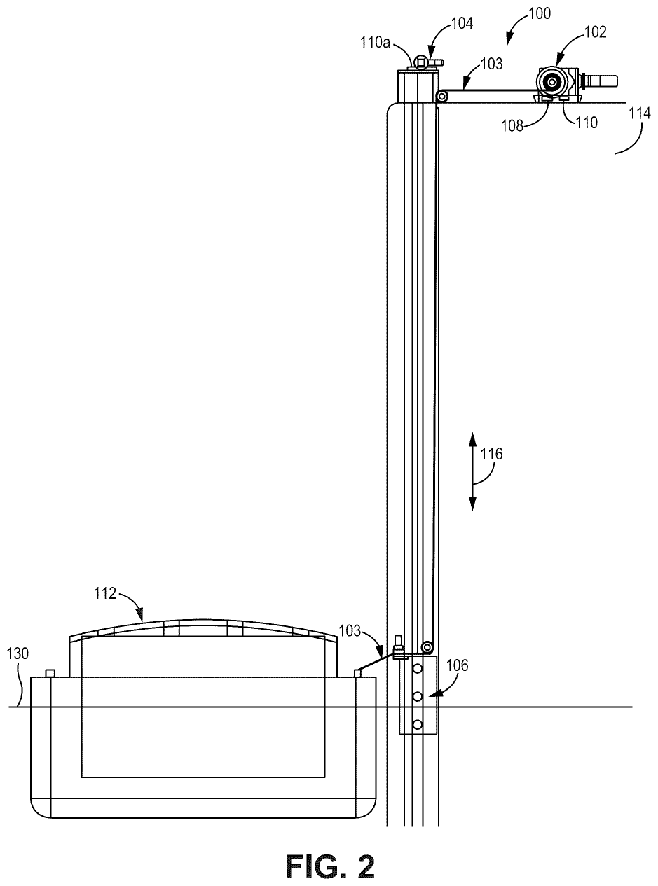

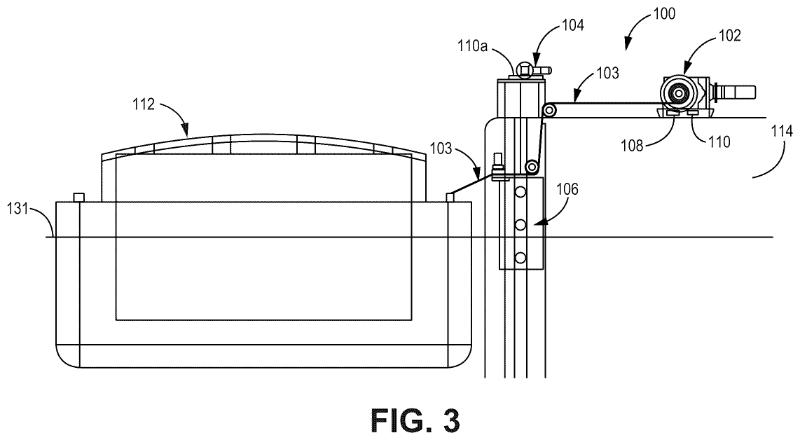

FIGS. 2 and 3 show a side elevational view of the vessel mooring system 100. Specifically, FIG. 2 illustrates the vessel mooring system 100 with the vessel 112 at a first water elevation level 130, and FIG. 3 illustrates the vessel mooring system 100 with the vessel 112 at a second, different (higher) water elevation level 131. FIGS. 2 and 3 are intended to show an exemplary operation of the vessel mooring system 100 applied to a barge, as the vessel 112, and applied during a locking process that causes the water elevation level to change from the first water elevation level 130 to the second, different water elevation level 131.

When the vessel 112 enters the lock, the mooring line 103 can be attached to the vessel 112 (e.g., at the kevel 113 manually by a deckhand) and the vessel mooring system 100 can be activated. With the system 100 activated, any personnel present at the vessel 112 can leave the vessel and the areas adjacent the system 100 need not have personnel present. Activation of the system 100 can cause an automated vessel mooring function to be activated such that manual actions by personnel to moor the vessel 112 may not be needed.

When the system 100 is activated, the sensor 108 can be configured to detect at least data corresponding to a magnitude of tension present in the mooring line 103. And the programmable controller 110 can be configured to receive this data corresponding to the magnitude of tension present in the mooring line 103 from the sensor 108. The programmable controller 110 can be configured to monitor the magnitude of tension present in the mooring line 103, for instance, by comparing the magnitude of tension present in the mooring line 103 to a predetermined tension threshold. When the magnitude of tension present in the mooring line 103 matches the predetermined tension threshold, the programmable controller 110 can be configured to take no action with respect to the tension hoist 102 and/or the elevation hoist 104. On the other hand, when the magnitude of tension present in the mooring line 103 differs from the predetermined tension threshold, the programmable controller 110 can be configured to actuate one or both of the tension hoist 102 and the elevation hoist 104 to change the magnitude of tension present in the mooring line 103 to come within the predetermined tension threshold. For instance, the programmable controller 110 can: actuate the tension hoist 102 to extend or retract the mooring line 103, relative to the tension hoist 102, to thereby cause a change in the length of the mooring line 103 between the tension hoist 102 and the vessel 112 to, in turn, cause a change in the magnitude of tension present in the mooring line 103 and/or actuate the elevation hoist 104 to change the elevation of the mooring cart 106, in the direction 116, to, in turn, cause a change in the magnitude of tension present in the mooring line 103 to come within the predetermined tension threshold.

The following will provide an illustrative example of this operation of the vessel mooring system 100 when the water elevation level changes, in reference to FIGS. 2 and 3.

In reference to FIG. 2, the sensor 108 can detect data corresponding to the magnitude of tension present in the mooring line 103. And the programmable controller 110 can be configured to receive this data corresponding to the magnitude of tension present in the mooring line 103 from the sensor 108. In the case of the instance in time illustrated at FIG. 2, the water elevation level and/or the lock load requirements may be generally constant. As such, as the programmable controller 110 can monitor the magnitude of tension present in the mooring line 103 by comparing the magnitude of tension present in the mooring line 103 to a predetermined tension threshold, and in some instances the generally constant nature of the water elevation level and/or the lock load requirements can result in the magnitude of tension present in the mooring line 103 being within the predetermined tension threshold. As a result, the programmable controller 110 can be configured to take no action with respect to the tension hoist 102 and/or the elevation hoist 104 since the monitored magnitude of tension present in the mooring line 103 is determined to be within the predetermined tension threshold.

However, in this example, as the water elevation level changes, for instance from the first water elevation level 130 present in FIG. 2 to the second, different water elevation level 131 present in FIG. 3, the magnitude of tension present in the mooring line 103 can change. Accordingly, as the programmable controller 110 monitors the magnitude of tension present in the mooring line 103 by comparing the magnitude of tension present in the mooring line 103 to a predetermined tension threshold, the changing nature of the water elevation level (and/or the lock load requirements) can result in the magnitude of tension present in the mooring line 103 changing and, thereby, falling outside of the predetermined tension threshold. As a result of the magnitude of tension present in the mooring line 103 changing and falling outside of the predetermined tension threshold, the programmable controller 110 can be configured to actuate one or both of the tension hoist 102 and the elevation hoist 104 to change the magnitude of tension present in the mooring line 103 to come within the predetermined tension threshold. For instance, the programmable controller 110 can actuate the tension hoist 102 to extend or retract the mooring line 103, relative to the tension hoist 102, to thereby cause a change in the length of the mooring line 103 between the tension hoist 102 and the vessel 112 to, in turn, cause a change in the magnitude of tension present in the mooring line 103. Additionally or alternatively, the programmable controller 110 can actuate the elevation hoist 104 to change the elevation of the mooring cart 106, in the direction 116, to, in turn, cause a change in the magnitude of tension present in the mooring line 103 to come within the predetermined tension threshold.

In this way, as a water elevation level at the lock and/or load requirements at the lock change, the programmable controller 110 can be configured to automatically actuate the tension hoist 102 and/or the elevation hoist 104 to cause the magnitude of tension in the mooring line 103 to change to be within the predetermined tension threshold. Notably, the vessel mooring system 100 can execute this operation without needing a deckhand, or other personnel, to manually adjust the magnitude of tension in the mooring line 103. Also notable, the described configuration of the vessel mooring system 100 can be mechanical in nature and may not need active electrical power input to operate (e.g., a battery can be used for electrically powering the sensor 108 and programmable controller 110). Instead, the tension hoist 102 and elevation hoist 104 can be actuated and operate based on mechanical forces such that the tension hoist 102 and elevation hist 104 can be actuated mechanically, without needing input electrical power, to cause a change in the magnitude of tension present in the mooring line 103.

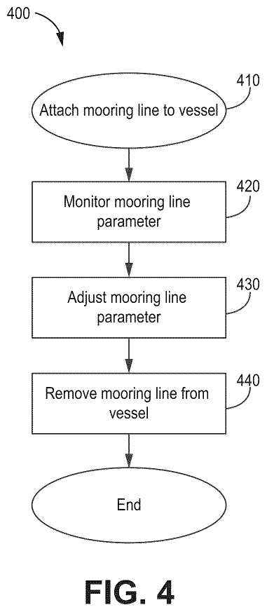

FIG. 4 shows a flow diagram of an embodiment of a method 400 for mooring a vessel. For example, the method 400 can be executed, at least in part, utilizing any embodiment of the vessel mooring system 100 disclosed herewith.

Prior to step 410, in certain embodiments, the method 400 can include a vessel (e.g., a barge) entering a defined area, such as a lock.

At step 410, the method 400 can include the step of attaching a mooring line to a vessel. The mooring line can be attached to the vessel, for instance, manually by a deckhand. This could include the deckhand tying the mooring line to an attachment point (e.g., kevel) at the vessel. Once the mooring line is attached to the vessel, the method 400 at step 410 can include the deckhand exiting the vessel and lock. Then, the vessel mooring system can be activated and the lock process can begin.

At step 420, the method 400 can include the step of monitoring at least one parameter associated with a mooring line that moors the vessel to a fixed structure (e.g. a dock). For example, at step 420, the method can include detecting (e.g., via a sensor of the vessel mooring system) at least data corresponding to a magnitude of tension present in the mooring line. And this data corresponding to the magnitude of tension present in the mooring line can be compared to a predetermined tension threshold as one way to monitor a parameter associated with the mooring line that moors the vessel to the fixed structure. In some embodiments, step 420 can further include generating one or more alerts, for instance one or more alerts relating to one or more parameters of a moored vessel, or more specifically a mooring line, as disclosed elsewhere herein.

At step 430, the method 400 can include the step of adjusting the at least one parameter associated with the mooring line. For example, the at least one parameter associated with the mooring line can include tension in the mooring line, and, in this example, the method can include monitoring the tension in the mooring line (at step 420) and, when the monitored tension in the mooring line differs from a predetermined mooring line tension threshold, step 430 can include adjusting the tension in the mooring line. Step 430 can adjust the tension in the mooring line, for instance, by using a tension hoist to, for instance, extend or retract the mooring line, and/or an elevation hoist to, for instance, adjust an elevation of a mooring cart that is attached to an elevation line that can be extended or retracted by the elevation hoist, at the fixed structure to thereby bring the tension in mooring line within the predetermined mooring line tension threshold. Notably, in various embodiments, the monitoring (step 420) and adjusting (step 430) steps can be carried out without a need for manual efforts at the mooring line, thereby helping to reduce and/or eliminate manual, hand-on actions for adjusting tension, and other parameters, in the mooring line.

At step 440, the method 400 can include the step of removing the mooring line from the vessel. For instance, when the lock process is completed (e.g., and the water level in the lock, and thus the vessel, has reached its desired elevation), the vessel mooring system can be deactivated and at this time a deckhand can come on-board the vessel and manually remove the mooring line from the vessel. Then the vessel can exit the lock (e.g., at a different elevation of the water surface than when the vessel entered the lock).

Various non-limiting exemplary embodiments have been described. It will be appreciated that suitable alternatives are possible without departing from the scope of the examples described herein.

What is claimed is:

1. A vessel mooring system comprising:
a tension hoist coupled to a mooring line, the mooring line configured to couple to a vessel;
an elevation hoist coupled to an elevation line, the elevation line configured to couple to a mooring cart;
a sensor configured to sense at least one parameter associated with the mooring line; and
a programmable controller in communication with the sensor, the programmable controller configured to compare the at least one parameter associated with the mooring line sensed by the sensor to a predetermined mooring line parameter threshold and, when the at least one parameter associated with the mooring line differs from the predetermined mooring line parameter threshold, the programmable controller is configured to cause at least one of the tension hoist to adjust the mooring line and the elevation hoist to adjust the elevation line.

2. The system of claim 1, wherein, when the at least one parameter associated with the mooring line differs from the predetermined mooring line parameter threshold, the programmable controller is configured to cause at least one of the tension hoist to adjust the mooring line and the elevation hoist to adjust the elevation line to an extent that brings the at least one parameter associated with the mooring line back to the predetermined mooring line parameter threshold.

3. The system of claim 2, wherein, when the at least one parameter associated with the mooring line differs from the predetermined mooring line parameter threshold, the programmable controller is configured to cause at least one of the tension hoist to adjust the mooring line and the elevation hoist to adjust the elevation line to an extent that brings the at least one parameter associated with the mooring line back to the predetermined mooring line parameter threshold without manual input.

4. The system of claim 2, wherein the at least one parameter associated with the mooring line comprises tension in the mooring line such that the sensor is configured to sense at least tension at the mooring line.

5. The system of claim 4, wherein the programmable controller is configured to compare at least tension at the mooring line sensed by the sensor to the predetermined mooring line parameter threshold and, when at least the tension at the mooring line differs from the predetermined mooring line parameter threshold, the programmable controller is configured to cause at least one of the tension hoist to adjust the mooring line and the elevation hoist to adjust the elevation line to an extent that brings at least the tension at the mooring line back to the predetermined mooring line parameter threshold.

6. The system of claim 5, wherein, when at least the tension at the mooring line differs from the predetermined mooring line parameter threshold, the programmable controller is configured to cause both the tension hoist to adjust the mooring line and the elevation hoist to adjust the elevation line to an extent that brings at least the tension at the mooring line back to the predetermined mooring line parameter threshold.

7. The system of claim 6, wherein, to bring the tension at the mooring line back to the predetermined mooring line parameter threshold, the programmable controller is configured to: (i) cause the tension hoist to adjust the mooring line by causing the tension hoist to extend or retract the mooring line, relative to the tension hoist, to thereby cause a change in length of the mooring line between the tension hoist and the vessel and (ii) cause the elevation hoist to adjust an elevation of the mooring cart to thereby cause a change in the tension at the mooring line.

8. The system of claim 7, wherein the programmable controller is configured to cause the tension hoist to extend or retract the mooring line, relative to the tension hoist, in one direction that is orthogonal to another direction in which the programmable controller is configured to cause the elevation hoist to adjust the elevation of the mooring cart.

9. The system of claim 7, further comprising:
the mooring cart, wherein the mooring cart is coupled to each of the mooring line and the elevation line.

10. The system of claim 9, wherein the mooring cart is buoyant, wherein the mooring cart comprises a line eyelet component that is configured to receive the mooring line therethrough, and wherein the mooring cart is adjustable in elevation via the elevation line and elevation hoist.

11. The system of claim 9, wherein the tension hoist is located at a fixed structure that is adjacent to the vessel, and wherein the elevation hoist is located at the fixed structure that is adjacent to the vessel.

12. The system of claim 11, wherein the elevation hoist is located at the fixed structure in axial alignment with the mooring cart, and wherein the tension hoist is offset from each of the axially aligned elevation hoist and mooring cart.

13. A method comprising the steps of:
attaching a first portion of a mooring line to a vessel, wherein a second portion of the mooring line is attached to a tension hoist;
when the mooring line is attached to the vessel, sensing, via a sensor, at least one parameter associated with the mooring line; and
when the mooring line is attached to the vessel and when the at least one sensed parameter associated with the mooring line differs from a predetermined mooring line parameter threshold, using the tension hoist to adjust the mooring line to bring the at least one parameter associated with the mooring line within the predetermined mooring line parameter threshold without manual input.

14. The method of claim 12, wherein using the tension hoist to adjust the mooring line to bring the at least one parameter associated with the mooring line within the predetermined mooring line parameter threshold without manual input comprises using a programmable controller, in communication with the sensor, to compare the at least one parameter associated with the mooring line sensed by the sensor to the predetermined mooring line parameter threshold and, when the at least one parameter associated with the mooring line differs from the predetermined mooring line parameter threshold, using the programmable controller to cause the tension hoist to adjust the mooring line without manual input.

15. The method of claim 14, wherein the at least one parameter associated with the mooring line comprises tension in the mooring line such that sensing, via the sensor, the at least one parameter associated with the mooring line comprises sensing, via the sensor, tension in the mooring line.

16. The method of claim 15, wherein using the tension hoist to adjust the mooring line to bring the at least one parameter associated with the mooring line within the predetermined mooring line parameter threshold without manual input comprises using the programmable controller to compare the tension in the mooring line to the predetermined mooring line parameter threshold and, when the tension in the mooring line differs from the predetermined mooring line parameter threshold, using the programmable controller to cause the tension hoist to adjust the tension in the mooring line without manual input to bring the tension in the mooring line back to the predetermined mooring line parameter threshold.

17. The method of claim 13, further comprising the step of:
when the mooring line is attached to the vessel and to a mooring cart and when the at least one sensed parameter associated with the mooring line differs from a predetermined mooring line parameter threshold, in addition to using the tension hoist to adjust the mooring line, using an elevation hoist to adjust an elevation of the mooring cart to adjust the mooring line to bring the at least one parameter associated with the mooring line within the predetermined mooring line parameter threshold without manual input.

18. The method of claim 17, wherein, to bring the at least one sensed parameter associated with the mooring line back to the predetermined mooring line parameter threshold, (i) the tension hoist adjusts the mooring line by extending or retracting the mooring line, relative to the tension hoist, to thereby cause a change in length of the mooring line between the tension hoist and the vessel without manual input and (ii) the elevation hoist adjusts the elevation of the mooring cart without manual input.

19. The method of claim 18, wherein the tension hoist adjusts the mooring line by extending or retracting the mooring line, relative to the tension hoist, in one direction that is orthogonal to another direction in which the elevation hoist adjusts the elevation of the mooring cart.

20. The method of claim 18, wherein the mooring cart is buoyant, and wherein the mooring cart is coupled to each of the mooring line and the elevation hoist.
